(19) United States
(12) Patent Application Publication
(10) Pub. No.: US 2014/0223158 A1
(43) Pub. Date: Aug. 7, 2014

(54) BOOTING DISPLAY CONTROL METHOD AND RELATED PROCESSOR CHIP

(71) Applicant: MediaTek Singapore Pte. Ltd., Singapore (SG)

(72) Inventors: Weibin Zhou, Shenzhen City (CN); Kunzhen Yang, Hefei City (CN)

(73) Assignee: MediaTek Singapore Pte. Ltd., Singapore (SG)

(21) Appl. No.: 14/027,159

(22) Filed: Sep. 14, 2013

(30) Foreign Application Priority Data
Feb. 5, 2013 (CN) 201310046270.1

(51) Int. Cl. G06F 9/44

(52) U.S. Cl. CPC G06F 9/4405
USPC 713/2

(57) ABSTRACT

A booting display control method and a processor chip are disclosed in the present invention. The processor chip includes at least a first processor, a second processor and a display control module. The second processor is coupled to the first processor. The display control module is coupled to the first processor and the second processor. After the first processor and the second processor are activated, the first processor will load an image file of an operating system and start the operating system, and the second processor will control the display control module to realize a booting display function. The booting display control method and the processor chip can be implemented in the fast display during the booting process.

### BACKGROUND

The invention relates to automotive electronics technology, and more particularly, to a booting display control method and a related processor chip.

Since more and more operating systems are applied in a variety of electronic devices, it is possible for the electronic devices to realize more and more functions. Generally, in an existing operating system based electronic device, an operating system is started up right after system booting, and then build-in functions of the operating system will be active after completion of the start-up of the operating system. Alternatively, an operating system is started up right after system booting, and during the start-up procedure of the operating system, the build-in functions of the operating system will be active by temporarily suspending the start-up procedure of the operating system in a time-sharing manner.

Currently, a booting display function of an operating system based electronic device requires the electronic device to be ready for normal use right after booting process is complete, and the start-up time of the operating system is not extended during the process. For example, the automotive industry requires a short response time of a reversing video display of a reversing camera system. In general, once a car is started, the reversing video must be displayed on the screen within 3 seconds. That is to say, the automotive industry requires the operating system based electronic device to realize the reversing video display function within 3 seconds since booting. For another example, a booting animation display function of the electronic device is required to not introduce any delay to the start-up time of the operating system.

In general, it takes more than ten seconds or even longer for an operating system to complete the start-up. If the user needs to view the reversing video while starting his/her car, since the reversing display function will be only activated after the start-up of the operating system is complete in a current automotive electronic device, time for viewing the reversing video is greatly increased. Currently, there is a conventional method to improve above situations by adding a chip in the automotive electronic device, wherein the video decoding chip controls display and video input, and the reversing video is outputted to the screen directly through the chip. While the conventional method avoids the problem of displaying the reversing video only after the start-up of the operating is complete; it increases the production cost dramatically. In addition, in order to improve the user experience while the user is starting the automotive electronic device, the current automotive electronic device displays the booting animation by suspending the start-up procedure of the operating system in a timing-sharing manner. However, this would increase the start-up time of the operating system inevitably.

### SUMMARY

In view of this, the present invention provides a booting display control method and a processor chip.

According to an embodiment of the present invention, a booting display control method is disclosed. The booting display control method is based on a processor chip which includes at least a first processor, a second processor and a display control module. The booting display control method includes: starting the first processor; starting the second processor; loading an image file of an operating system via the first processor and starting the operating system; and controlling the display control module to realize a booting display function via the second processor.

According to another embodiment of the present invention, a processor chip is disclosed. The processor chip is used for booting display control, and the processor chip includes a first processor; a second processor, coupled to the first processor; and a display control module, coupled to the first processor and the second processor. After the first processor and the second processor are activated, the first processor loads an image file of an operating system and start the operating system, and the second processor controls the display control module to realize a booting display function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a processor chip based automotive electronic device according to an embodiment of the present invention.

FIG. 2 is a flowchart illustrating a booting display control method according to a first embodiment of the present invention.

FIG. 3 is a flowchart illustrating a booting display control method according to a second embodiment of the present invention.

FIG. 4 is a flowchart illustrating a booting display control method according to a third embodiment of the present invention.

FIG. 5 is a flowchart illustrating a booting display control method according to a fourth embodiment of the present invention.

FIG. 6 is a flowchart illustrating a booting display control method according to a fifth embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

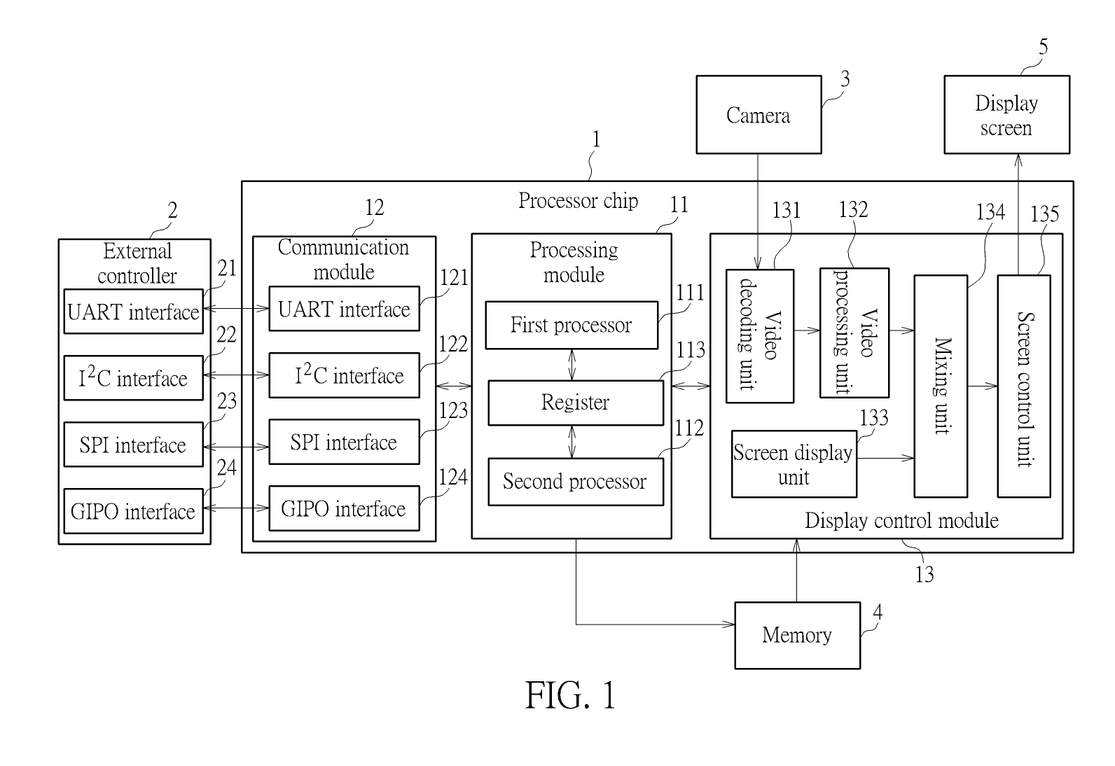

Please refer to FIG. 1, which is a diagram illustrating a processor chip based automotive electronic device according to an embodiment of the present invention. The automotive electronic device may be an on-board unit (OBU), an automotive navigation device, or a portable navigation device (PDN). As shown in FIG. 1, the automotive electronic device includes a processor chip 1, an external controller 2, a camera 3, a memory 4 and a display screen 5.

The processor chip 1 is used for controlling operations of the automotive electronic device, including the booting display of the automotive electronic device (e.g., start-up reversing video display and/or booting animation display). Specifically, when the processor chip 1 realizes the start-up reversing video display, the processor chip 1 obtains a reversing state flag from the external controller 2; and when the reversing state flag indicates that the car is reversing, the processor chip 1 displays the video obtained from the camera 3 on the display screen 5. At the same time, the processor chip 1 reads reversing data and derives the reversing trajectory plot, and stores the reversing trajectory plot into the memory 4 for further being superimposed on the video, wherein as the reversing trajectory plotting is well known to those skilled in the pertinent art, detail is omitted here for brevity. When the processor chip 1 realizes the booting animation display, the processor chip 1 reads image data of the booting animation and displays it on the display screen 5. Furthermore, the processor chip 1 may determine which image is to be displayed according to the reversing state flag obtained from the external controller 2. For instance, when the reversing state flag indicates that the car is reversing, the reversing video will be displayed; otherwise, the booting animation will be displayed.

In this embodiment, the processor chip 1 includes a processing module 11, a communication module 12, and a display control module 13. The processing module 11 includes a first processor 111, a second processor 112, and a register 113. The communication module 12 includes a Universal Asynchronous Receiver/Transmitter (UART) interface 121, an Inter-Integrated Circuit (I²C) interface 122, a Serial Peripheral Interface (SPI) interface 123, and a General Purpose Input/Output (GIPO) interface 124. The display control module 13 includes a video decoding unit 131, a video processing unit 132, a screen display unit 133, a mixing unit 134, and a screen control unit 135.

In this embodiment, the first processor 111 and the second processor 112 can individually control the display control module 13 to realize the booting display function, respectively. In addition, the first processor 111 executes the operating system, and the second processor 112 executes fewer codes and functions, the first processor 111 is therefore activated slower than the second processor 112.

Specifically, after the first processor 111 and the second processor 112 are both activated, the first processor 111 will load an image file of the operating system and start up the operating system, and the second processor 112 will control the display control module 13 to realize a booting display function. More specifically, the second processor 112 controls the display control module 13 to realize a booting display function while the first processor 111 loads the image file of the operating system and starts up the operating system.

In addition, the second processor 112 cyclically/repeatedly detects whether the start-up of the operating system is complete. If the start-up of the operating system is not complete yet, the second processor 112 controls the display control module 13 to realize the booting display function. If the start-up of the operating system has been complete, the first processor 111 will take place of the second processor 112 to control the display control module 13 to realize the booting display function. The second processor 112 detects a start-up state flag in the memory 4 or the register 113 shared by the first processor 111 and the second processor 112 for determining whether the operating system has been started up. Once the start-up of the operating system is complete, the first processor 111 sets the start-up state flag as ‘start-up complete’. If the second processor 112 detects that the start-up state flag indicates ‘start-up complete’, the second processor 112 will determine that the start-up of the operating system is complete.

For example, in a case where the booting display function is a booting reversing video display, during the start-up process of the operating system, the second processor 112 cyclically/repeatedly detects the reversing state flag after initializing the display control module 13. Once the second processor 112 detects that the reversing state flag indicates the car is reversing, the second processor 112 controls the display control module 13 to display the reversing video. Specifically, the display control module 13 reads reversing data from the external controller 2 and derives a reversing trajectory plot, wherein the reversing trajectory plot is further superimposed on the video obtained from the camera. Once the start-up process of the operating system is complete, the first processor 111 notifies the second processor 112 to stop detecting the reversing state flag, and starts a reversing application program so as to control the display control module 13.

For another example, in a case where the booting display function is a booting animation display, during the start-up process of the operating system, the second processor 112 controls the display control module 13 to display the booting animation after initializing the display control module 13. Once the start-up process of operating system is complete, the first processor 111 notifies the second processor 112 to stop displaying the booting animation, and controls the display control module 13 instead.

For yet another example, in a case where the booting display function is the booting reversing video display and the booting animation display, during the start-up process of the operating system, the second processor 112 cyclically/repeatedly detects the reversing state flag after initializing the display control module 13. If the reversing state flag indicates the car is not reversing, the second processor 112 controls the display control module 13 to display the booting animation. Once the second processor 112 detects that the reversing state flag indicates the car is reversing, it controls the display control module 13 to display the reversing video. After the start-up process of the operating system is complete, the first processor 111 notifies the second processor 112 to stop detecting the reversing state flag, and starts a reversing application program so as to control the display control module 13.

In this embodiment, the register 113 is shared by the first processor 111 and the second processor 112. The first processor 111 and the second processor 112 are capable of performing read/write operations upon the register 113 and exchanging information through the register 113.

In this embodiment, the communication module 12 is coupled to the external controller 2 so as to obtain the reversing state flag and the reversing data.

The video decoding unit 131 controls the input of the video captured by the camera 3. The video processing unit 132 is coupled to the video decoding unit 131, and arranged for processing the video captured by the camera 3. The screen display unit 133 is used for realizing a superimposed display of multiple images. The mixing unit 134 is coupled to the video processing unit 132, the screen display unit 133, and the display control unit 135, and arranged for mixing the video and the image so as to make a superimposed display presented on the display screen 5 via the display control unit 135, wherein the display control unit 135 is used for driving the display screen 5.

The external controller 2 is used for detecting the reversing state of the car and transmitting the corresponding reversing state flag to the processor chip 1. For instance, when the external controller 2 determines that the car is operating in a reverse gear, it transmits a corresponding reversing state flag to the processor chip 1; when the external controller 2 determines that the gear is shifted from the reverse gear state to a different gear state, it transmits a corresponding reversing state flag indicative of an end of the reversing to the processor chip 1; and when the external controller 2 determines that the car is operating in a specific gear (e.g., a forward gear) different from the reverse gear, it transmits a corresponding reversing state flag to the processor chip 1.

Furthermore, when the external controller 2 detects that the car is reversing, the external controller 2 transmits the reversing data obtained from external device such as a reversing radar (not shown) to the processor chip 1 for be further processed and then shown on the display screen 5.

Specifically, the external controller 2 includes the UART interface 21, the I²C interface 22, the SPI interface 23 and the GPIO interface 24, which are respectively coupled to the UART interface 121, the I²C interface 122, the SPI interface 123 and the GPIO interface 124 of the processor chip 1. The external controller 2 transmits the reversing state flag to the processing module 11 of the processor chip 1 via at least one of the UART interface 21, the I²C interface 22, the SPI interface 23 and the GPIO interface 24. Moreover, the external controller 2 transmits the reversing data to the processing module 11 of the processor chip 1 via at least one of the UART interface 21, the I²C interface 22, and the SPI interface 23.

The camera 3 is used for capturing the image behind the car. Specifically, the camera 3 is coupled to the video decoding unit 131 of the processor chip 1, and the video decoding unit 131 receives the video data captured by the camera 3 and transmits to the video processing unit 132 for further processing, such as noise reduction process. After that, the processed video data will be passed to the display control unit 135 and then shown on the display screen 5.

The memory 4 is used for storing the image data of the booting animation and image data of the reversing trajectory plot. Specifically, the memory 4 is coupled to the processing module 11 and the display control module 13. The processing module 11 transmits the image data of the booting animation and image data of the reversing trajectory plot stored in the memory 4 to the display control unit 135 via the screen display unit 133 and the mixing unit 134 for image display on the display screen 5, wherein the revering trajectory plot is obtained according to the reversing data read by the first processor 111 or the second processor 112. Furthermore, the memory 4 is commonly used by the first processor 111 and the second processor 112, and the first processor 111 and the second processor 112 are capable of performing read/write operations upon the memory 4 and exchanging information through the memory 4. Besides, in another embodiment, the memory 4 may be used to store images captured by the camera 3 or the decoded data outputted from the video decoding unit 131.

The display screen 5 is coupled to the display control unit 135, and arranged for displaying images such as the booting animation, the reversing video and/or the reversing trajectory plot.

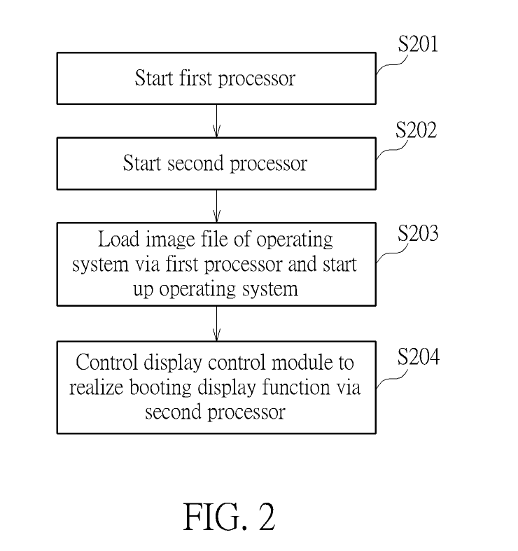

FIG. 2 is a flowchart illustrating a booting display control method according to a first embodiment of the present invention. The booting display control method is performed based on a processor chip 1. Please note that, provided that substantially the same result is achieved, the steps in FIG. 2 need not to be executed in the exact order shown and need not to be contiguous, that is, other steps can be intermediate. As shown in FIG. 2, the method includes following steps:

Step S201: Start the first processor 111;

Step S202: Start the second processor 112;

Step S203: Load an image file of an operating system via the first processor 111 and start up the operating system;

Step S204: Control the display control module 13 to realize a booting display function via the second processor 112.

In a preferred embodiment, step S203 and step S204 are performed simultaneously.

In Step S201, during the start-up of the first processor 111, the first processor 111 executes a boot loader program. Those skilled in the art will appreciate that the boot loader program is the first program executed by the automotive electronic device. By means of this program, functions such as initializing hardware devices or building memory mapping tables, are realized.

In step S202, the first processor 111 starts the second processor 112 through the boot loader program. Specifically, the first processor 111 starts the second processor 112 through loading an image file of the second processor 112, wherein the image file of the second processor 112 may be stored in a lower-speed memory (e.g. a NAND flash memory), and the image file of the second processor 112 is copied to a higher-speed memory (e.g. a random access memory (RAM)) from the lower-speed memory by the first processor 111 to start the second processor 112. Once the second processor 112 is started, the image file of the second processor 112 is performed to control the display control module 13 for realizing the booting display function.

In step S203, the first processor 111 copies the image file of the operating system stored in the lower-speed memory (e.g. a NAND flash memory) to the higher-speed memory (e.g. a RAM) and execute the image file to start the operating system. By way of example, but not limitation, the operating system could be Linux, uClinux, WinCE, or uCOS-II. Besides, after reading the present specification, those skilled in the art should readily understand that the present invention can be applied to any appropriate operating system, and the type of the operating system is not a limitation of the present invention.

In step S204, the second processor 112 is used for controlling the display control module 13 to realize the booting display function. Specifically, through the second processor 112, the video decoding unit 131, the video processing unit 132, the display control unit 135, and the screen display unit 133 can be well controlled to realize the function of displaying reversing video and/or booting animation while booting.

According to the above-mentioned method, the display in the start-up process (e.g. reversing video display or booting animation display in the start-up process) can be improved by utilizing the second processor to realize the booting display function while the first processor is starting the operating system, thereby solving the problems encountered in the prior art (e.g., the booting display function (such as the booting display reversing video) can not be normally used during the start-up of the operating system, or the booting display function can be used during the start-up process but would increase the start-up time of the operating system).

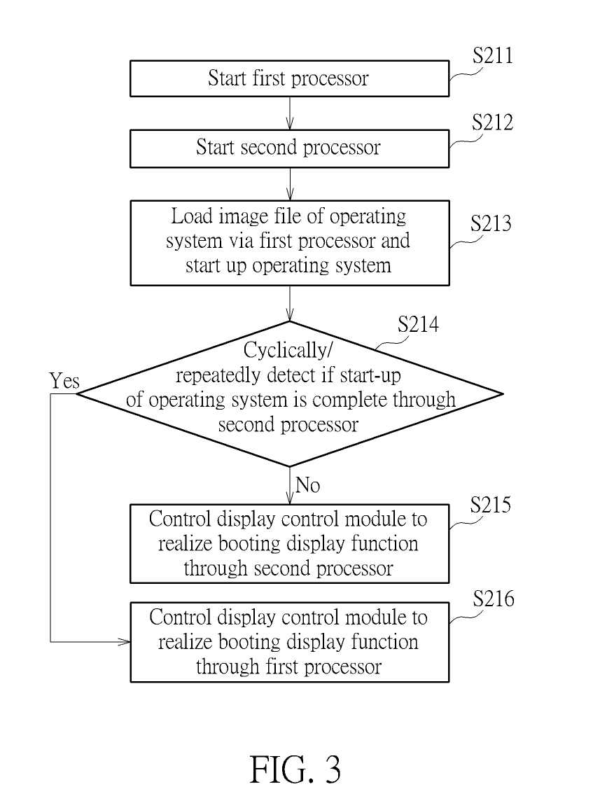

FIG. 3 is a flowchart illustrating a booting display control method according to a second embodiment of the present invention. The booting display control method is performed based on a processor chip 1. Please note that, provided that substantially the same result is achieved, the steps in FIG. 3 need not to be executed in the exact order shown and need not to be contiguous, that is, other steps can be intermediate. As shown in FIG. 3, the method includes following steps.

Step S211: Start the first processor 111.

Step S212: Start the second processor 112.

Step S213: Load an image file of an operating system via the first processor 111 and start up the operating system.

In this embodiment, steps S211, S212, and S213 are similar to steps S201, S202, and S203 in FIG. 2. Hence, the details are omitted here for brevity.

Step S214: Cyclically/repeatedly detect if the start-up of the operating system is complete through the second processor 112. If not, the flow goes to step S215; otherwise, the flow goes to step S216. In step S214, the second processor 112 is used for further determining if the start-up of the operating system is complete through detecting a start-up state flag in the memory 4 or the register 113 shared by the first processor 111 and the second processor 112. Specifically, the transmission of the start-up state flag between the first processor 111 and the second processor 112 is realized through an exclusive access. In this embodiment and other embodiments, the start-up state flag is preserved/maintained in a certain storage unit of the memory 4 or a certain register (e.g., register 113), and indicated by at least one-bit binary value stored therein. For instance, if the operating system has been started, the start-up state flag will be set as ‘1’ to indicate start-up completion; otherwise, the start-up state flag will be set as ‘0’ to indicate start-up incompletion. The setting of the start-up state flag can be modified according to design requirements. The first processor 111 and the second processor 112 perform exclusive access upon the start-up state flag. To put it another way, the first processor 111 and the second processor 112 are not allowed to perform read/write operations upon the start-up state flag simultaneously, so as to avoid the start-up state flag error introduced due to performing read/write operations simultaneously by the first processor 111 and the second processor 112.

In this embodiment, if the operating system has not been started, the first processor 111 will set the start-up state flag as ‘0’ to indicate start-up incompletion; and if the operating system has been started, the first processor 111 will rewrite the start-up state flag as ‘1’ to indicate start-up completion. During the start-up process of the operating system, the second processor 112 cyclically/repeatedly detects if the start-up state flag indicates that the start-up of the operating system is complete. That is, the second processor 112 cyclically/repeatedly reads the start-up state flag and determines whether the start-up state flag is ‘1’. When it is detected that the start-up state flag is ‘0’, the second processor 112 will determine that the start-up of the operating system is not complete yet and the flow goes to step S215. When it is detected that the start-up state flag is ‘1’, the second processor 112 will determine that the start-up of the operating system is complete and the flow goes to step S216.

Step S215: Control the display control module 13 to realize the booting display function through the second processor 112. In step S215, the start-up of the operating system is not complete yet, and the second processor 112 therefore takes over the booting display function. Specifically, during the start-up process of the operating system, the second process 112 is arranged to control the video decoding unit 131, the video processing unit 132, the display control unit 135, and the screen display unit 133 to realize the function of displaying reversing video and/or booting animation while booting.

Step S216: Control the display control module 13 to realize the booting display function through the first processor 111. In step S216, the operating system is complete, and the first processor 111 therefore takes over the booting display function. Specifically, once the start-up process of the operating system is complete, the first process 111 is utilized to control the video decoding unit 131, the video processing unit 132, the display control unit 135, and the screen display unit 133 to realize the display function.

According to the above-mentioned method, the booting display function (e.g. reversing video display or booting animation display in the start-up process) can be improved by utilizing the second processor to realize the booting display function while the first processor is starting the operating system, and then utilizing the first processor to continue the booting display function after the start-up of the operating system is complete. That is, the first processor and the second processor are capable of independently and respectively controlling functions of the display control module (such as the video decoding/processing function and the display control/screen display function) inside the chip. The second processor and the first processor are utilized respectively during and after the start-up process, thus control the display control module alternately. Above method is capable of solving the problems encountered in the prior art (e.g., the booting display function (such as the booting display reversing video) can not be normally used during the start-up of the operating system, or the booting display function can be used during the start-up process but would increase the start-up time of the operating system).

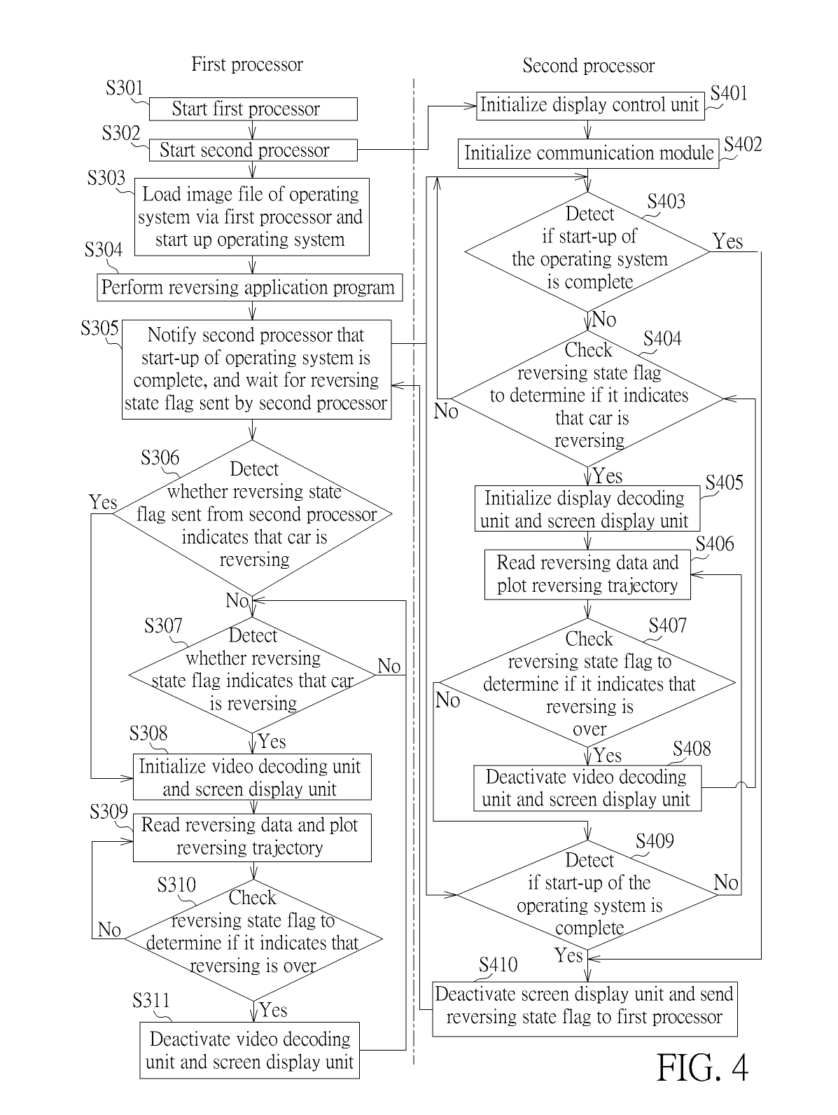

FIG. 4 is a flowchart illustrating a booting display control method according to a third embodiment of the present invention. Please note that, provided that substantially the same result is achieved, the steps in FIG. 4 need not to be executed in the exact order shown and need not to be contiguous, that is, other steps can be intermediate. As shown in FIG. 4, the booting display control method is described along with an example of displaying reversing video while booting, the method includes following steps.

Step S301: Start the first processor 111.

Step S302: Start the second processor 112.

Step S303: Load an image file of an operating system via the first processor 111 and start up the operating system.

In this embodiment, steps S301, S302, and S303 are similar to steps S201, S202, and S203 in FIG. 2. Hence, the details are omitted here for brevity.

Step S304: Utilize the first processor to perform a reversing application program. In step S304, the reversing application program refers to the program which is developed and performed by the operating system for the reversing video function. In this embodiment, after the operating system is started, the first processor 111 activates the reversing application program to continue displaying the reversing video.

Step S305: Control the first processor to notify the second processor that the start-up of the operating system is complete, and wait for the reversing state flag sent by the second processor. In step S305, the first processor 111 configures the start-up state flag as ‘start-up complete’ so as to inform the second processor 112 of the start-up completion, wherein the start-up state flag is preserved/maintained in the memory 4 or the register 113 shared by the first processor 111 and the second processor 112. Then, the first processor 1112 waits for the reversing state flag sent from the second processor 112, wherein the reversing state flag could also be transmitted via the memory 4 or the register 113.

As to the operation of the second processor 112, since the first processor 111 needs to receive the reversing state flag sent by the second processor 112 in step S305, the flow will enter step S401 after step S302 is finished.

Step S401: Control the second processor to initialize the display control unit. In step S401, the second processor 112 initializes the display control unit 135 such as initializing registers of the display control unit (i.e., writing corresponding values into the registers of the display control unit to drive the display working normally based on the model, performance, or operating mode of the display). Meanwhile, in order to improve the user experience, during the start-up of the operating system after booting, the second processor 112 could control the display screen 5 to play booting images such as a trademark image after the display control unit 135 is initialized and ready for driving the display screen 5 for normal display.

Step S402: Control the second processor to initialize the communication module. In step S402, the second processor 112 initializes the communication module 12. The second processor 112 mainly configures parameters of the communication module 12 such as the transmission bit rate, the data transmission mode, etc., so as to drive the communication module 12 to communicate with the external controller 2 normally, wherein the communication module 12 could be the UART interface, the I²C interface, the SPI interface or the GPIO interface.

Step S403: Control the second processor to detect if the start-up of the operating system is complete. If yes, the flow goes to step S410; otherwise, the flow goes to step S404. In step S403, during the process where the second processor 112 realizes the reversing video display function while booting, the second processor 112 cyclically/repeatedly detects the start-up state flag which indicates the start-up state of the operating system. If the start-up state flag indicates that the operating system is started, the flow continues to perform step S410; otherwise, the flow continues to perform step S404.

Step S404: Control the second processor to check the reversing state flag and determine if the reversing state flag indicates that the car is reversing. If yes, the flow goes to step S405; otherwise, the flow goes to step S403. In step S404, the second processor 112 obtains the reversing state flag from the external controller 2 via the communication module 12 or the GPIO interface 124, wherein the reversing state flag corresponds to the data received through the communication module 12, or corresponds to the high/low voltage level of the GPIO interface 124. By way of example, but not limitation, the correspondence could be configured according to the predetermined rules. For instance, it could be configured that the high voltage level of the GPIO interface 124 corresponds to the reversing state of the reversing state flag, or it could be configured that the received data 0x55 of the communication module 12 corresponds to the reversing state of the reversing state flag. The second processor 112 determines whether the car is reversing according to the reversing state flag. If the reversing state flag indicates that the car is reversing, then the display control module 13 will be controlled to display the reversing video; otherwise, the flow continues to detect if the start-up of the operating system is complete.

Step S405: Initialize the display decoding unit and the screen display unit. It could be understood that the screen display unit 133 may include a screen display unit corresponding to reversing trajectory plot and a screen display unit corresponding to the booting image, which can superimpose multiple images shown on the display screen 5, the screen display unit 133 may also include screen display unit corresponding to other functions. In step S405, the second processor 112 initializes the video decoding unit 131 for activating the video decoding unit 131 to receive the reversing video input captured by the camera 3, so as to further allow the reversing video to be displayed. The second processor 112 initializes the screen display unit corresponding to the reversing trajectory plot so as to superimpose the reversing trajectory plot on the reversing video shown on the display screen, thereby improving the user experience.

Step S406: Read reversing data and plot the reversing trajectory. In step S406, the second processor 112 reads the reversing data from the external controller 2 via the communication module 12 and plots the reversing trajectory according to the reversing data, so as to further update the displayed reversing trajectory plot.

Step S407: Check the reversing state flag and determine if it indicates the reversing is over. If yes, the flow goes to step S408; otherwise, the flow goes to step S409.

For instance, in this embodiment, it could be configured that the transition from the high voltage level to the low voltage level of the GPIO interface 124 corresponds to an end of the reversing state as indicated by the reversing state flag, or it could be configured that the received data 0x66 of the communication module 12 corresponds to an end of the reversing state as indicated by the reversing state flag. In this way, it is determined that the reversing is over when the above-mentioned case happens.

Step S408: Deactivate the video decoding unit and the screen display unit, and continue to perform step S404.

Once the second processor 112 detects that the reversing state flag indicates the reversing is over, the video decoding unit 131 and the screen display unit 133 will be deactivated for disabling the function of displaying reversing video while booting. In another embodiment, it can also turn to detect whether the start-up of the operating system is complete (step S403) after the second processor 112 deactivates the video decoding unit 131 and the screen display unit 133. If the operating system is started completely, then the second processor 112 will send the reversing state flag to the first processor 111 and the flow will proceed with step S305.

Step S409: Control the second processor to detect if the start-up of the operating system is complete. If yes, the flow goes to step S410; otherwise, the flow goes to step S406.

In this embodiment, step S409 and step S403 both control the second processor 112 to detect if the start-up of the operating system is complete. Step S403 is performed before displaying reversing video while booting, and step S409 is performed during displaying reversing video while booting. Step S409 can greatly increase the efficiency of alternately controlling the display control module 13 for displaying reversing video. Specifically, suppose that the reversing lasts for several minutes. Since an operating system usually takes dozen seconds to complete the start-up process, if the state of the operating system is detected only before the reversing video displaying, it will make the first processor 111 and the second processor 112 unable to operate alternately for realizing the function of performing the reversing video display by the first processor 111 within the several minutes when the car is reversing. This would dramatically lower the efficiency of alternately displaying the reversing video by the first processor 111 and the second processor 112.

Step S410: Deactivate the screen display unit and send the reversing state flag to the first processor. In step S410, once the second processor 112 determines that the start-up of the operating system is complete, the second processor 112 deactivates the screen display unit 133. If the screen display unit corresponding to the reversing trajectory plot is activated, screen display units other than those corresponding to the reversing trajectory plot and video display (e.g., the screen display unit corresponding to booting animation) will be deactivated.

Specifically, if the operating system is detected as started completely in step S403, since the reversing video is not displayed, the second processor 112 will deactivate all of the screen display units and send the reversing state flag which indicates that no reversing video is displayed to the first processor 111, and the flow will go back to step S305.

If the operating system is detected as started completely in step S409, since the reversing video is being displayed now, the second processor 112 will deactivate screen display units other than those corresponding to the reversing trajectory plot and send the reversing state flag which indicates that the car is reversing to the first processor 111, and the flow will go back to step S305. After step S305, the flow will proceed with step S306.

Step S306: Detect whether the reversing state flag sent from the second processor indicates that the car is reversing. If yes, the flow goes to step S308; otherwise, the flow goes to step S307. In step S306, after the second processor 112 finishes performing step S410, the first processor 111 will determine if the reversing state flag received from the second processor 112 indicates that the car is reversing.

Step S307: Detect whether the reversing state flag indicates that the car is reversing. If yes, the flow goes to step S308; otherwise, the flow goes to step S307. In step S307, the first processor 111 receives the reversing state flag from the external controller 2 via the communication module 12 or the GPIO interface 124, and determines if the reversing state flag indicates that the car is reversing. If the reversing state flag indicates that the car is reversing, the first processor 111 controls the display control module 13 to continue displaying the reversing video; otherwise, the first processor 111 will continue detecting the reversing state flag.

Step S308: Initialize the video decoding unit and the screen display unit. In step S308, if the first processor 111 determines that the reversing state flag indicates the car is reversing, the first processor 111 will initialize the video decoding unit 131 and the screen display unit corresponding to the reversing trajectory plot. If the video decoding unit 131 has been initialized, then it needs not to be initialized again. Specifically, when the first processor 111 receives the reversing state flag from the second processor 112 and the reversing state flag indicates the car is reversing, there is no need to initialize the video decoding unit 131 again.

Step S309: Read the reversing data and plot the reversing trajectory.

Step S310: Check the reversing state flag and determine if it indicates that the reversing is over. If yes, goes to step S311; otherwise, goes to step S309.

Step S311: Deactivate the video decoding unit and the screen display unit, and goes to step S307.

Steps S309, S310, and S311 are similar to steps S406, S407, and S408 in the present invention. Hence, the details are omitted here for brevity.

According to the above-mentioned method, the display in the start-up process can be impproved by utilizing the second processor 112 to realize the reversing video display while booting during the time period in which first processor 111 is starting the operating system, and the utilizing the first processor 111 to continue the reversing video display function after the start-up of the operating system is complete. That is, the first processor 111 and the second processor 112 are capable of independently and respectively controlling functions of the display control module (such as the video decoding/processing function and the display control/displaying function) inside the chip. Hence, the second processor 112 and the first processor 111 are utilized respectively during and after the start-up process to therefore control the display control module 13 alternately for fast reversing video display, thereby solving the problems encountered in the prior art (e.g., the reversing video can not be normally displayed during the start-up of the operating system).

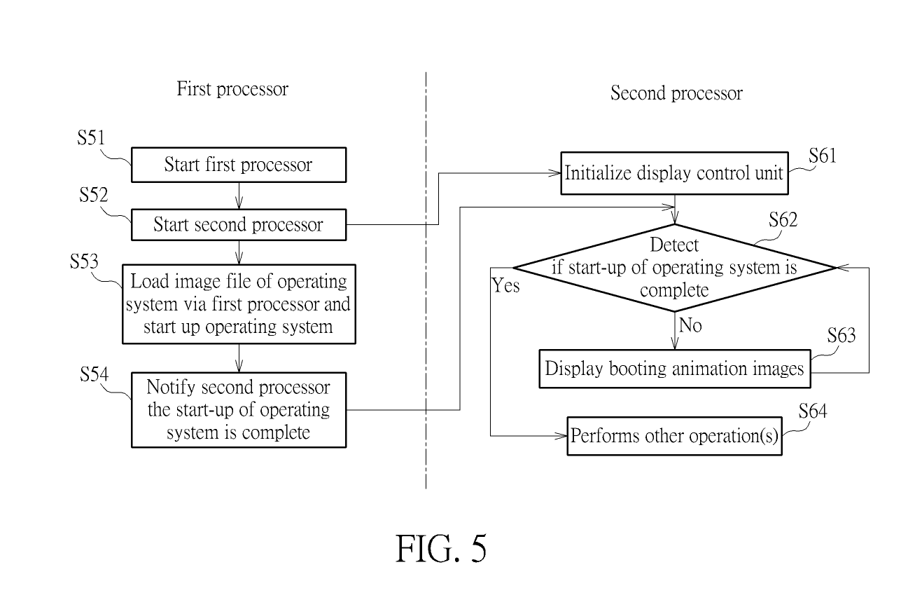

FIG. 5 is a flowchart illustrating a booting display control method according to a fourth embodiment of the present invention. Please note that, provided that substantially the same result is achieved, the steps in FIG. 5 need not to be executed in the exact order shown and need not to be contiguous, that is, other steps can be intermediate. As shown in FIG. 5, the booting display control method is described along with an example of booting animation display, the method includes following steps:

Step S51: Start the first processor 111.

Step S52: Start the second processor 112.

Step S53: Load an image file of an operating system via the first processor 111 and start up the operating system.

In this embodiment, steps S51, S52, and S53 are similar to steps S201, S202, and S203 in FIG. 2. Hence, the details are omitted here for brevity.

Step S54: The first processor notifies the second processor the start-up of the operating system is complete. In step S54, after the operating system is started completely, the first processor 111 configures the start state flag as ‘start-up complete’ so as to notify the second processor 112 the start-up of the operating system is complete and further notify the second processor 112 to stop displaying the booting animation and hand over the control of the display control module 13 to the first processor 111, wherein the start-up state flag is preserved/maintained in the memory 4 and register 113 shared by the first processor 111 and the second processor 112.

As to the second processor 112, after step S52 is finished, the second processor 112 will perform step S61.

Step S61: Control the second processor to initialize the display control unit to drive the display screen work normally.

Step S62: Control the second processor to detect if the start-up of the operating system is complete. If yes, the second processor performs other operation(s) (step S64); otherwise, the second processor keeps performing step S63. In step S62, the second processor 112 cyclically/repeatedly detects the start-up state flag during the booting animation display process. If the start-up state flag indicates that the operating system has been started, the second processor 112 stops the booting animation display and perform other operations. If the start-up state flag indicates that the operating system is currently being started or is not started yet, the second processor 112 continues the booting animation display process.

Step S63: Display the booting animation images, and go back to step S62. In Step S63, the second processor 112 divides the booting animation stored in the memory 4 into several frames, and displays one frame for each predetermined time interval according to the frame number of the booting animation. Specifically, the second processor 112 displays the N^{th} frame of the booting animation for each predetermined time interval, wherein N=(N+1) % MAX, MAX is the total frame number of the booting animation, and N=1, 2, . . . , MAX. That is, the second processor 112 firstly displays the first frame of the booting animation, and then sequentially displaying the second, the third, . . . till the MAX^{th} frame. After the MAX^{th} frame is displayed, next loop will be started from the first frame. Meanwhile, during the process of displaying each frame, the second processor 112 cyclically/repeatedly detects if the operating system is started completely.

According to the above-mentioned method, by utilizing the second processor 112 to realize the booting animation display while the first processor 111 is starting the operating system, the problems encountered in the prior art are solved. For example, the increased start-up time of the operating system resulting from temporarily suspending the start-up of the operating system for realizing the booting animation display is avoided.

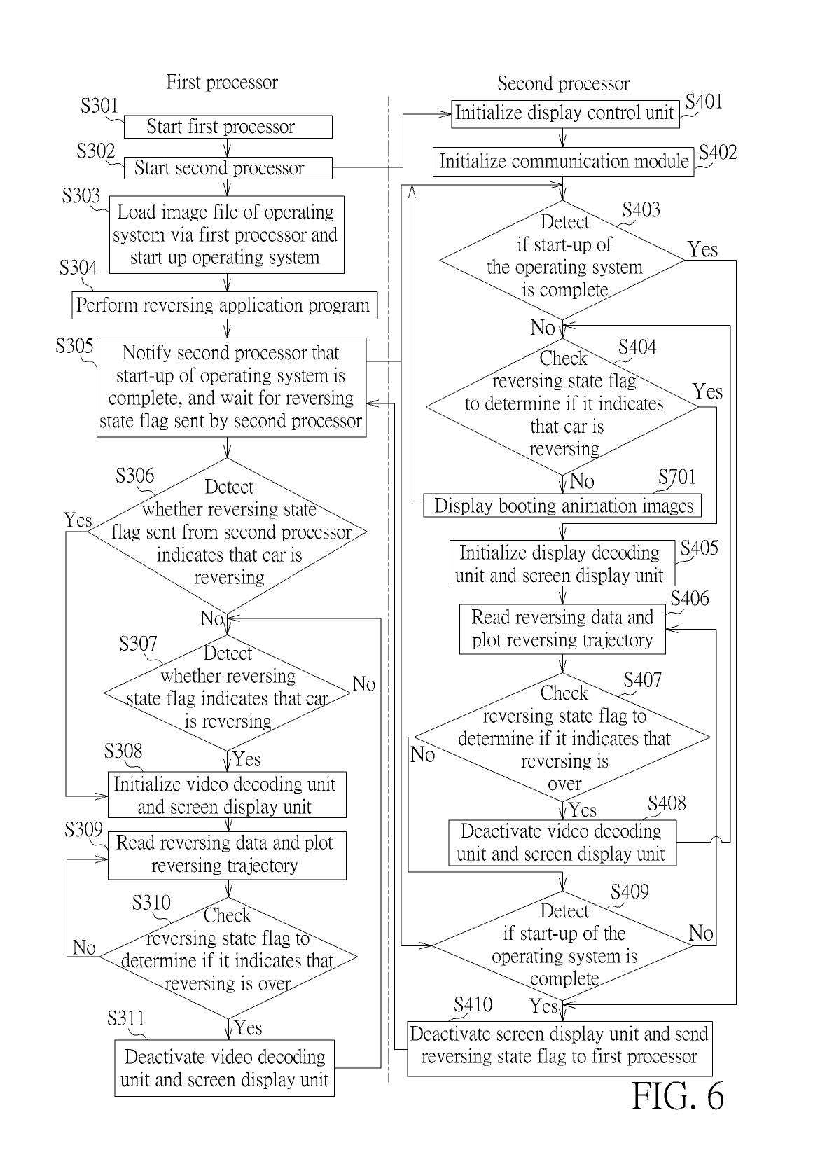

FIG. 6 is a flowchart illustrating a booting display control method according to a fifth embodiment of the present invention. The booting display control method is described along with an example of booting reversing video display and booting animation display.

As can be seen in FIG. 6, the main difference between the fifth embodiment in FIG. 6 and the third embodiment in FIG. 4 is that, after step S404, FIG. 6 further includes step S701, which is described as follows.

Step S701: Display the booting animation images, and then go back to step S403.

Specifically, based on the embodiment shown in FIG. 4, after step S404 is done and the second processor 112 detects that the reversing state flag indicates ‘not reversing’, the booting animation frames will be displayed cyclically. If the second processor 112 detects that the reversing state flag indicates ‘reversing’, the reversing video will be displayed. Meanwhile, during the process of displaying each frame, the second processor 112 cyclically/repeatedly detects if the start-up of the operating system is complete.

Since other steps shown in FIG. 6 have been disclosed in FIG. 4, the details are omitted here for brevity.

According to the above-mentioned methods, by utilizing the second processor to realize the reversing video display while booting and the booting animation images display during the time period in which the first processor is starting the operating system, the problems encountered in the prior art are solved. For example, the problem caused by the reversing video unable to be displayed while the operating system is being started is solved. At the same time, according to this embodiment, the booting animation display function can be realized under the premise of not extending the operating system start-up time, thus improving the user experience.

The above descriptions are illustrated as embodiments of the present invention only, and are not for limiting the scope of the present invention. Any equivalent structures, equivalent process transformation, or direct or indirect use in other related arts made by utilizing the present specification and drawings of the present invention are all similarly included within the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A booting display control method, based on a processor chip which includes at least a first processor, a second processor and a display control module, the booting display control method comprising:
starting the first processor;
starting the second processor;
loading an image file of an operating system via the first processor and starting the operating system; and
controlling the display control module to realize a booting display function via the second processor.

2. The booting display control method of claim 1, further comprising:
utilizing the second processor to cyclically detect whether a start-up of the operating system is complete;
when the start-up of the operating system is not complete yet, controlling the display control module to realize the booting display function via the second processor; and
when the start-up of the operating system is complete, controlling the display control module to realize the booting display function via the first processor.

3. The booting display control method of claim 2, wherein the step of utilizing the second processor to cyclically detect whether the start-up of the operating system is complete comprises:
controlling the second processor to detect a start-up state flag in a memory or a register shared by the first processor and the second processor, wherein after the start-up of the operating system is complete, the first processor sets the start-up state flag as ‘start-up complete’;
controlling the second processor to detect if the start-up state flag indicates ‘start-up complete’; and
when the start-up state flag indicates ‘start-up complete’, the second processor determines that the start-up of the operating system is complete.

4. The booting display control method of claim 2, wherein the step of controlling the display control module to realize the booting display function via the second processor comprises:
initializing the display control module via the second processor;
cyclically detecting a reversing state flag, and when the second processor detects that the reversing flag indicates ‘reversing’, controlling the display control module to display reversing video.

5. The booting display control method of claim 4, wherein the step of controlling the display control module to display the reversing video comprises:
displaying video obtained from a camera on a display screen; and
reading reversing data from an external controller and plotting reversing trajectory, and further superimposing a reversing trajectory plot on the video.

6. The booting display control method of claim 4, wherein the step of controlling the display control module to realize the booting display function via the first processor comprises:
after the start-up of the operating system is complete, notifying the second processor to stop detecting the reversing state flag and starting a reversing application program of the first processor so as to control the display control module via the first processor.

7. The booting display control method of claim 4, wherein the step of controlling the display control module to realize the booting display function via the second processor further comprises:
when the reversing state flag does not indicate ‘reversing’, displaying boot animation on the display screen.

8. The booting display control method of claim 2, wherein the step of controlling the display control module to realize the booting display function via the first processor comprises:
during the start-up of the operating system, displaying boot animation after initializing the display control module via the second processor; and
after the start-up of the operating system is complete, controlling the first processor to notify the second processor to stop displaying the booting animation, and utilizing the first processor to control the display control module.

9. The booting display control method of claim 1, wherein the step of starting the second processor further comprises:
starting the second processor through a boot loader program.

10. The booting display control method of claim 1, wherein the step of loading the image file of the operating system via the first processor and starting the operating system and the step of controlling the display control module to realize the booting display function via the second processor are performed simultaneously.

11. A processor chip for booting display control, comprising:
a first processor;
a second processor, coupled to the first processor; and
a display control module, coupled to the first processor and the second processor;
wherein after the first processor and the second processor are activated, the first processor loads an image file of an operating system and starts the operating system, and the second processor controls the display control module to realize a booting display function.

12. The processor chip of claim 11, wherein the second processor cyclically detects whether a start-up of the operating system is complete; when the start-up of the operating system is not complete yet, the second processor controls the display control module to realize the booting display function; and when the start-up of the operating system is complete, the first processor takes place of the second processor to control the display control module to realize the booting display function.

13. The processor chip of claim 12, wherein the second processor detects a start-up state flag in a memory or a register shared by the first processor and the second processor; after the start-up of the operating system is complete, the first processor sets the start-up state flag as ‘start-up complete’; and the second processor detects if the start-up state flag indicates ‘start-up complete’, wherein when the start-up state flag indicates ‘start-up complete’, the second processor determines that the start-up of the operating system is complete.

14. The processor chip of claim 11, wherein while the first processor is loading the image file of the operating system and starting the operating system, the second processor controls the display control module to realize the booting display function.

15. The processor chip of claim 11, wherein the second processor further initializes the display control module, and cyclically detects a reversing state flag; and when the second processor detects that the reversing flag indicates ‘reversing’, the second processor controls the display control module to display reversing video.

16. The processor chip of claim 15, wherein the second processor controls the display control module to read reversing data from an external controller and plots reversing trajectory; and
a reversing trajectory plot and video obtained from a camera are further superimposed on the display screen.

17. The processor chip of claim 15, wherein after the start-up of the operating system is complete, the first processor notifies the second processor to stop detecting the reversing state flag, and starts a reversing application program so as to control the display control module.

18. The processor chip of claim 15, wherein the processor chip further comprises a communication module; the communication module includes a Universal Asynchronous Receiver/Transmitter (UART) interface, an Inter—Integrated Circuit (I²C) interface, a Serial Peripheral Interface (SPI) interface, and a General Purpose Input/Output (GIPO) interface; the first processor and the second processor obtain the reversing state flag from the external controller via the communication module.

19. The processor chip of claim 15, wherein when the second processor detects that the reversing state flag does not indicate ‘reversing’, the second processor controls the display control module to display boot animation.

20. The processor chip of claim 11, wherein during the start-up of the operating system, the second processor initializes the display control module and controls the display control module to display boot animation; and after the start-up of the operating system is complete, the first processor notifies the second processor to stop displaying the booting animation, and controls the display control module.
